(19) United States
(12) Patent Application Publication
(10) Pub. No.: US 2003/0095749 A1
(43) Pub. Date: May 22, 2003

(54) Fiber coupler and compensation system

(75) Inventor: Qiushui Chen, Medford, MA (US)

Correspondence Address: James M. Smith, Esq., HAMILTON, BROOK, SMITH & REYNOLDS, P.C., 530 Virginia Road, P.O. Box 9133, Concord, MA, 01742-9133, US

(73) Assignee: Renka Corporation, Peabody, MA (US)

(21) Appl. No.: 10/001,265

(22) Filed: Nov. 21, 2001

(51) Int. Cl. G02B 6/34; G02B 6/27; G02B 6/32

(52) U.S. Cl. 385/36; 385/11; 385/33

(57) ABSTRACT

A coupler which couples a light signal from an input port to two more output ports. The coupler includes a multifaceted prism which separates an incoming light signal into selective portions and deflects these portions in different directions to the respective output ports. A lens is positioned between the output ports and the prism to focus the light signal from the prism to the output ports.

### BACKGROUND

In optical communication systems, the polarization dependent loss (PDL) of the various components in the system is a significant concern. Almost all of these components are designed to minimize the PDL, and it is not uncommon to see PDL specifications at 0.05 dB or less. While satisfying such criteria, optical couplers for some applications also require polarization maintaining (PM) capabilities. Typically, these PM couplers employ birefringent PM fibers for both the input and output fibers.

Presently, most fiber couplers are made by heating, twisting and pulling a bundle of optical fibers. The PDL of the couplers formed by this method is hard to control and minimize, and greatly depends on the operator's experience and skills. Also it is very difficult to preserve the required stress characteristics of the PM fibers during such processes when fabricating PM couplers.

Some have proposed making optical couplers by polishing the sides of two fibers nearly to the core. When the cores of the input and output fibers are in close proximity, light couples from one fiber to the other. However, this method requires very precise polishing and positioning of the fiber cores for a specified coupling ratio. Furthermore, the coupling ratio is subject to variations due to environmental conditions such as temperature and vibration. Accordingly, couplers made by this method usually couple an optical signal to no more than two output fibers.

Others have proposed coupling an input light signal to a plurality of light ports with prisms. However, these systems do not address various polarization issues.

### SUMMARY

The present invention is related to methods and apparatuses to couple a light signal from an input port to two more output ports. The coupler includes a prism which separates an incoming light signal into selective portions and deflects these portions in different directions to the respective output ports.

In certain embodiments, a coupler includes a multifaceted prism which transmits an input light signal from an input fiber to at least two output fibers, and a lens positioned between the output fibers and the prism to focus the light signal from the prism.

A second collimating lens may collimate the input light signal from the input fiber to the prism. Either or both lens may be a GRIN lens. The prism may be coated with an anti-reflection coating such as, for example, a dielectric material. The prism may be made of glass.

In some embodiments, the input fiber and/or the at least two output fibers may be polarization maintaining fibers, and in other embodiments, the fibers may be ordinary fibers. Thus, the coupler can be a polarization maintaining coupler. In these, as well as in other embodiments, the coupler may have a polarization dependent loss less than about 0.05 dB, and that can be less than 0.01 dB. An angle of incidence with the prism may be between about 0 to 10 degrees. In one embodiment, the angle of incidence is less than eight degrees.

The coupler may be used as a tunable coupler. In such embodiments, the prism may be moved in a plane orthogonal to the optical axis of the prism to vary the proportion of the light signal being sent to each output fiber.

In certain embodiments, a telecommunications system includes a variable attenuator which compensates for polarization dependent losses in an optical fiber network, an input optical transmission line which transmits signals to the attenuator, and an output optical transmission line that transmits signals from the attenuator. The input transmission line includes a polarization scrambler which randomly changes the polarization state of an input optical signal. The output transmission line includes a coupler that couples optical signals from an input optical fiber to two output optical fibers. One of the two output optical fibers is a tap line of the output transmission line that is fed to a control circuit which provides feedback signals to the attenuator. The tap line of the output transmission line provides samples of the power level of each polarization state. The coupler includes a multifaceted prism which receives the input light signal and directs a first portion of the light signal to one of the two output optical fibers and a remaining portion of the light signal to the other output optical fiber, and a lens which focuses the light signal from the prism to the output optical fibers.

In some embodiments, the first portion of the light signal may be at least 90% of the light signal, and in some embodiments may be about 95% of the light signal.

Some embodiments of this invention may provide one or more of the following advantages. The coupler has low a PDL, for example, less than 0.02 dB, and preferably less than 0.01 dB. The polarization maintaining coupler is easier to fabricate than couplers made by heating, twisting and pulling several PM fibers. The coupling ratio of the tunable coupler is insensitive to environmental variations like temperature and vibration. These couplers with low PDL are quite suitable in devices that require feedback control such as amplifiers and power levelers. Certain embodiments have low wavelength dependency loss (WDL) which is useful for broadband applications. In particular, the coupler of the present invention is able to provide the same coupling ratio for certain channels in a fiber carrying wavelength division multiplexing (WDM) signals.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is an illustration of a 1×7 fiber coupler in accordance with the invention.

FIG. 1B is an end view of a prism of the fiber coupler of FIG. 1A along the line 1B-1B.

FIG. 2 is schematic illustration of a 1×3 optical coupler showing certain optical characteristics of the coupler.

FIGS. 3A-3C illustrate a sequence of steps to form a facet of a splitting prism in accordance with the invention.

FIG. 4 is a graph of calculated values of polarization dependent loss in transmitted light versus the incident angle.

FIG. 5A is a perspective view of an alternative embodiment of a slitting prism for a 1×4 coupler.

FIG. 5B is a side view of the prism of FIG. 5A.

FIG. 5C illustrates the positioning pattern of the output fibers for the prism of FIGS. 5A and 5B.

FIG. 6A is a perspective view of another alternative embodiment of a slitting prism for a 1×4 coupler.

FIG. 6B is an end view of the prism of FIG. 6A.

FIG. 6C illustrates the positioning pattern of the output fibers for the prism of FIGS. 6A and 6B.

FIG. 7A is a perspective view of yet another alternative embodiment of a slitting prism for a 1×4 coupler.

FIG. 7B is an end view of the prism of FIG. 7A.

FIG. 7C illustrates the positioning pattern of the output fibers for the prism of FIGS. 7A and 7B.

FIGS. 8A-8D illustrate how the coupling ratio for a 1×3 coupler is changed by moving the splitting prism.

FIGS. 9A-9C illustrate the switching process of a 1×3 switching coupler.

FIG. 10 is a fiber coupler used in combination with a attenuator in a telecommunications system.

### DETAILED DESCRIPTION OF THE INVENTION

A description of preferred embodiments of the invention follows.

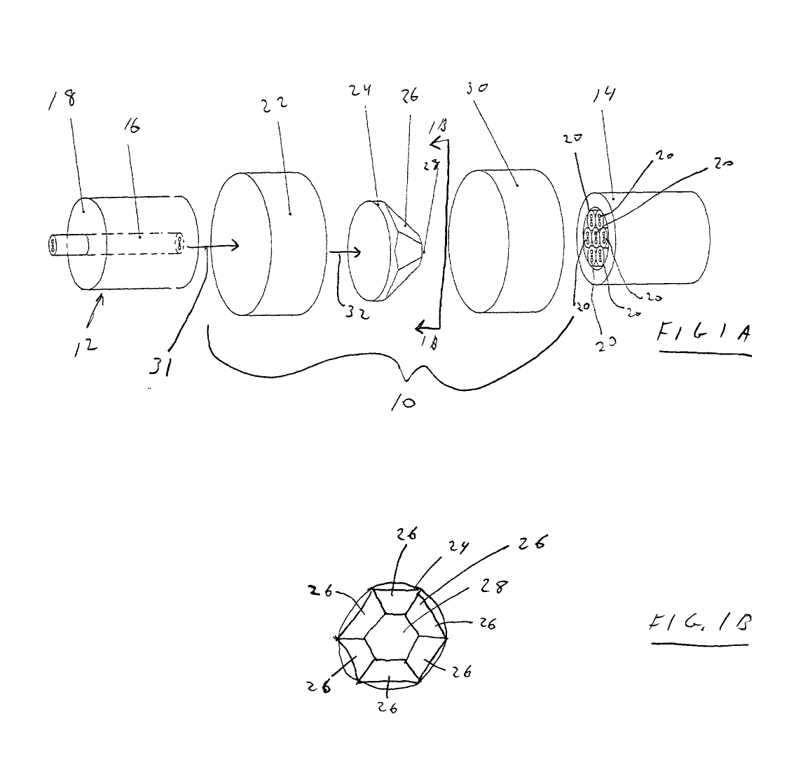

Referring to FIG. 1A, there is illustrated a 1×7 coupler in accordance with the present invention, generally referred to as 10. The coupler 10 directs light signals from an input port 12 to seven output ports 20 enclosed in a casing 14. The input port 12 includes a polarization maintaining (PM) fiber 16 that is held in a glass capillary tube 18, and the output ports 20 are a bundle of PM fibers. As the coupler 10 transmits the light signal from the input port 12 to the seven fibers 20, the coupler 10 maintains the polarization properties of the light signal.

The coupler 10 includes a collimating lens element 22 positioned between the input fiber 16 and a splitting prism 24. Referring in particular to FIG. 1B, the splitting prism 24 is provided with seven facets, six inclined facets 26 symmetrically surrounding one center facet 28. A second lens element 30 is positioned between the splitting prism 24 and the output ports 20.

A light beam 31 is directed from the input fiber 16 and is collimated by the lens 22. The splitting prism 24 splits the incoming collimated beam 32 into seven predetermined portions that are focused by the second lens 30 to a respective output fiber 20. Thus each portion of the split light beam is deflected in different directions by the individual facets 26 and 28 of the prism 24.

Turning now to the particular components of the coupler 10, the input fiber 16 and the output fibers 20 are polarization maintaining fibers. However, the coupler 10 is not limited for use with PM fibers. That is, any suitable optical fiber, including non-polarization maintaining fibers, can be used in place of the PM fibers 16 and 20.

As for the lens elements 22 and 30, they can be but are not limited to gradient index (GRIN) rods. If GRIN rods are used for the lens 22 and 30, the length of the rods should be about a quarter pitch to ensure that the light signal transmitted from each lens is well collimated. Some advantages of using collimated input beams include insensitivities to positioning errors (along the optical axis direction). Moreover, the collimating lens 22 ensures that the angle of incidence between the incoming beam and each inclined facet 26 is the same.

As described above, the coupler 10 is used as a PM coupler. However, the coupler 10 can also be used as an ordinary coupler with low polarization dependent loss (PDL). Further, although shown as a 1×7 coupler, the coupler 10 can be used as a 1×N coupler where N is the number of output ports, as well as the number of facets of the prism 24. For example, there is shown in FIG. 2 the prism 24 with three facets 39 for use in a 1×3 coupler. The 1×3 coupler 10 in FIG. 2 couples an incoming light beam 40 with the three output fibers 20. Note, to couple the light signal from the incoming light beam 40 to the output fibers 20, portions of the light beam 40 have an angle of incidence, θ, with the respective facet 39 of between about 0 to 10 degrees, since larger angles of incidence will produce corresponding large PDL according to Fresnel's reflection law. In some embodiments, the angle of incidence is less than eight degrees.

The angular variations of the deflected portions of the light signal, through the Fourier transform of the lens 30, correspond to focusing spots where the respective output fibers 20 are located. Accordingly, if a facet angle is α and the index of refraction of the prism is n, then the angle of deflection β of a deflected beam 41 is approximately (n−1)α.

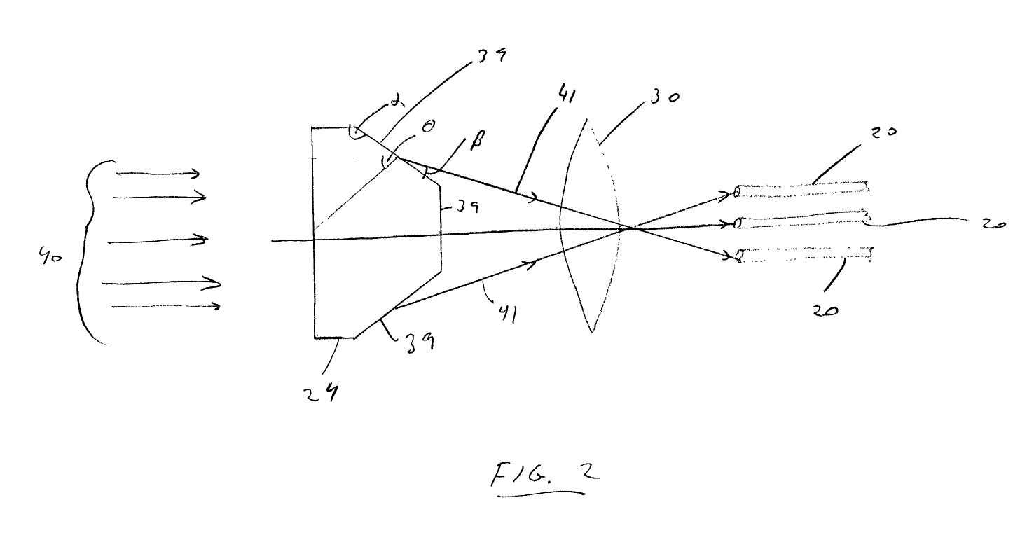

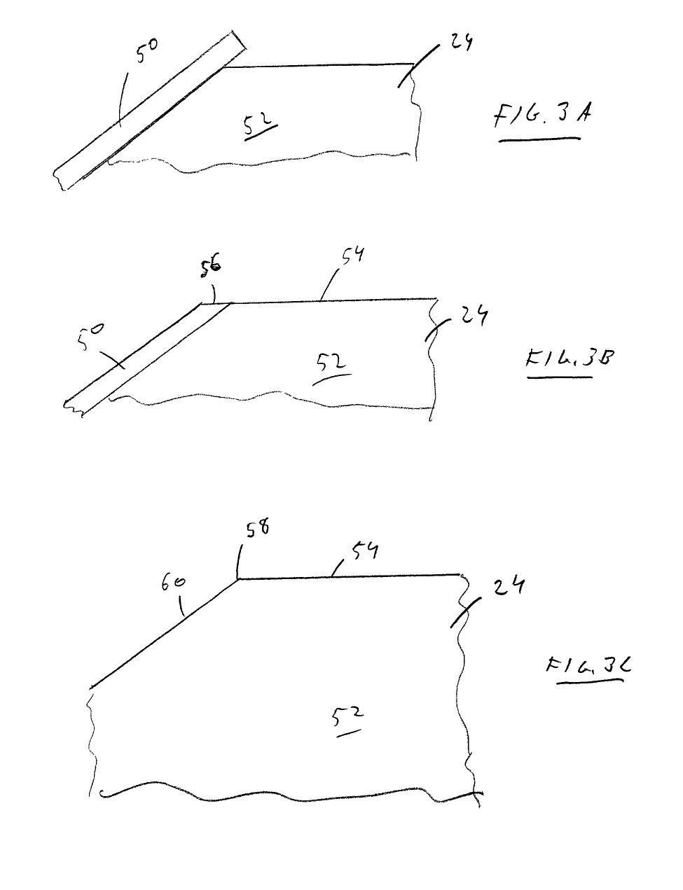

To further reduce the PDL produced by the prism 24, the width of the edges separating each facet of the prism should be minimized. That is, adjacent facets should form a sharp edge. To produce such edges, a facet of the prism 24 is fabricated as outlined in the sequence of steps illustrated in FIGS. 3A-3C.

First, as shown in FIG. 3A, a layer of glass 50 is attached by glue, wax, or any other suitable means to a prism substrate material 52.

Subsequently, a side 54 of the prism which becomes one of the prism's facets is polished (FIG. 3B) so that the end 56 of the layer of glass 50 forms a flat surface with the surface 54 of the prism substrate 52.

Finally, as shown in FIG. 3C, the glass is removed from the substrate 52 by heating or dissolving the adhesive means, or by ultrasonic methods, to yield a sharp edge 58 between the top facet 54 and the side facet 60. The procedure is then repeated for each additional facet.

Fabrication of the prism 24 is completed by applying an antireflection coating to each facet to further reduced the PDL of the prism. The antireflection coating is typically a dielectric material having a index of refraction different than that of the prism. The desirability of using an antireflection coating for reducing the PDL can be understood by referring to the graph illustrated in FIG. 4. The graph in FIG. 4 shows calculated curves of the PDL for transmitted light with a wavelength of 1550 nm versus the angle of incidence of the light beam with a glass/air interface, with and without an antireflection coating, according to Fresnel reflection principles.

In particular, the curve 201 represents the PDL versus the incident angle with an uncoated glass (fused silica)/air interface. One can see that the PDL due to Fresnel reflection is about 0.05 dB for incident angles of 20 degrees, and is under 0.01 dB for incident angles that are less than 8 degrees, with a minimum around 0 degrees.

However, when the interface is coated with an anti-reflection coating, the PDL can be reduced for particular incident angles. For instance, the curve 202 represents the PDL versus incident angle of an interface coated with an anti-reflection coating designed to shift the PDL minimum to an incident angle of 8 degrees. Accordingly, if the incident angle of the light beam with each facet is about 8 degrees, an anti-reflection coating applied to the facets reduces the reflection induced PDL to nearly zero. However, for practical applications, the incident angle for each facet will fall within a particular range. For example, for facets coated with the anti-reflection coating, the incidence angle can vary from 0 to 14 degrees, while the PDL remains less than 0.01 dB. Thus, for a prism with a PDL of less than 0.01 dB, the range of the incident angle is increased from 0 to 8 degrees (without the anti-reflection coating) to 0 to 14 degrees when a coating is applied to the facets.

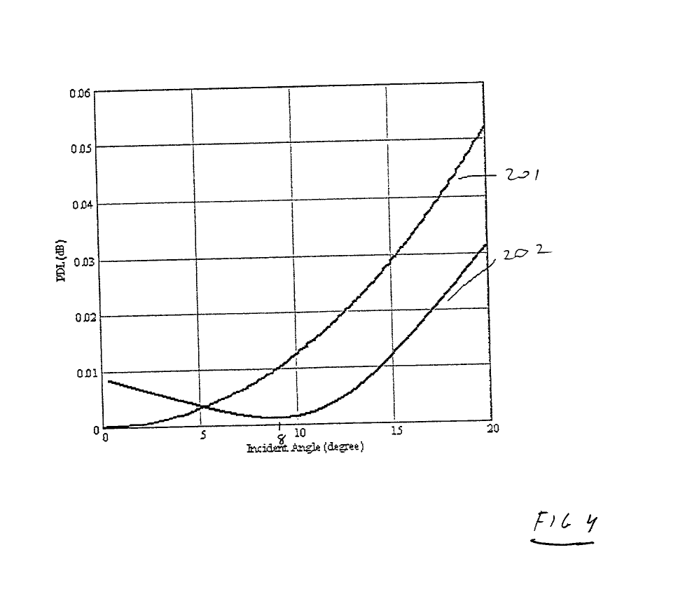

As mentioned above, the prism 24 can have multiple facets arranged in a number of configurations. For example, in FIGS. 5-7 there is shown three alternative embodiments of the splitting prism 24 for use in a 1×4 coupler.

Illustrated in particular in FIGS. 5A and 5B is a columnar prism 24 which includes four planar facets 70. The columnar prism 24 splits the incoming light signal into four portions and directs these portions to the output fibers 20 aligned along a line as illustrated in the right most drawing (FIG. 5C).

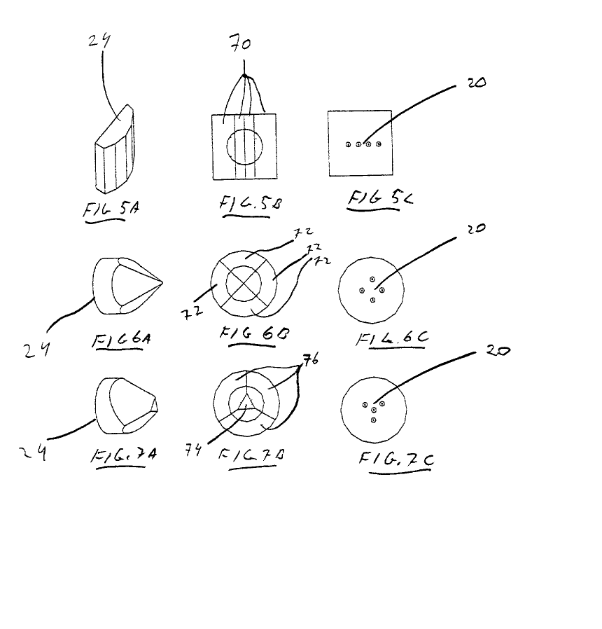

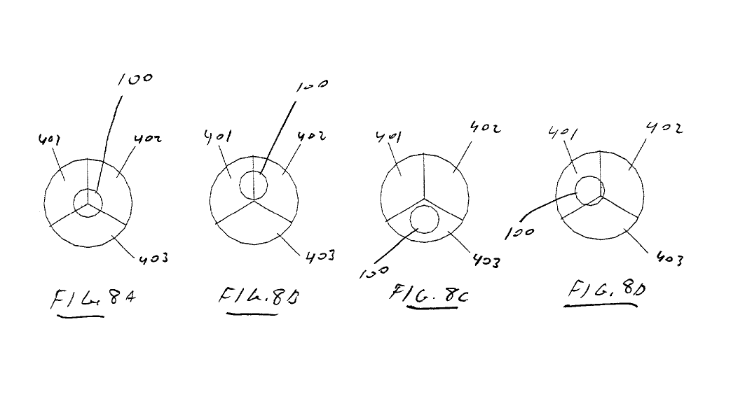

In FIGS. 6A and 6B, a pyramid shaped prism 24 with four facets 72 is shown, and in FIGS. 7A and 7B, a flat-topped triangular pyramid shape prism 24 with a central facet 74 surrounded by three side facets 76 is illustrated. Again, the right most figures FIGS. 6C and 7C, illustrate the positioning pattern of the output fibers for each configuration, respectively, while the central drawings, FIGS. 6B and 7B, schematically show the intercepted areas of incoming light signal for each case.

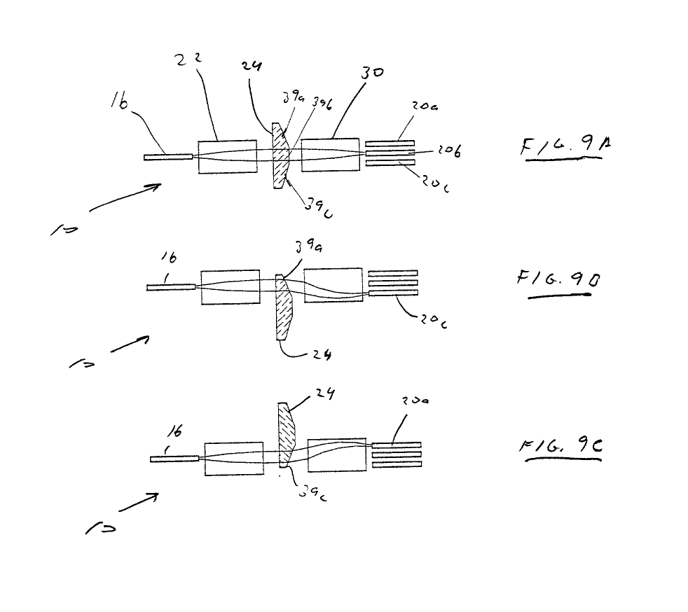

In some implementations, the coupler 10 is tunable or switchable so that the coupling ratio between the input light signal and the output fibers can be varied. Varying the coupling ratio is typically accomplished by moving the prism 24 with respect to the incoming light signal. For instance, there is shown in FIGS. 8A-8D, a triangular pyramid type of the splitting prism 24 used in a tunable 1×3 coupler.

By moving the splitting prism 24 in the plane normal to the direction of the incoming beam 100, different coupling ratios can be obtained as listed below in Table 1. The coupling ratio can be simply estimated by integrating the energy of the beam intercepted by the facets. Three output fibers (fiber 1, fiber 2, fiber 3) collect the energy portions corresponding to the faces 401, 402, and 403 of the prims 24.

TABLE 1
Coupling Ratios Corresponding to different
positions of the splitting prism

| | Case a | Case b | Case c | Case d |
|---|---|---|---|---|
| | (FIG. 8A) | (FIG. 8B) | (FIG. 8C) | (FIG. 8D) |
| Fiber 1 | 0.33 | 0.5 | 0 | 0.8 |
| Fiber 2 | 0.33 | 0.5 | 0 | 0.1 |
| Fiber 3 | 0.33 | 0 | 1 | 0.1 |

Since the coupling ratio is determined by the position of the splitting prism with respect to the incoming beam, the ratio can be designed to be a suitable value. Theoretically, any coupling ratio can be obtained. Unlike mode-coupling couplers, the the coupling ratio with the couplers of the present embodiments are not very sensitive to environmental conditions like temperature and vibration, and the tolerance for the positional variations of the couplers 10 are over a hundred times greater than that of mode-coupling couplers.

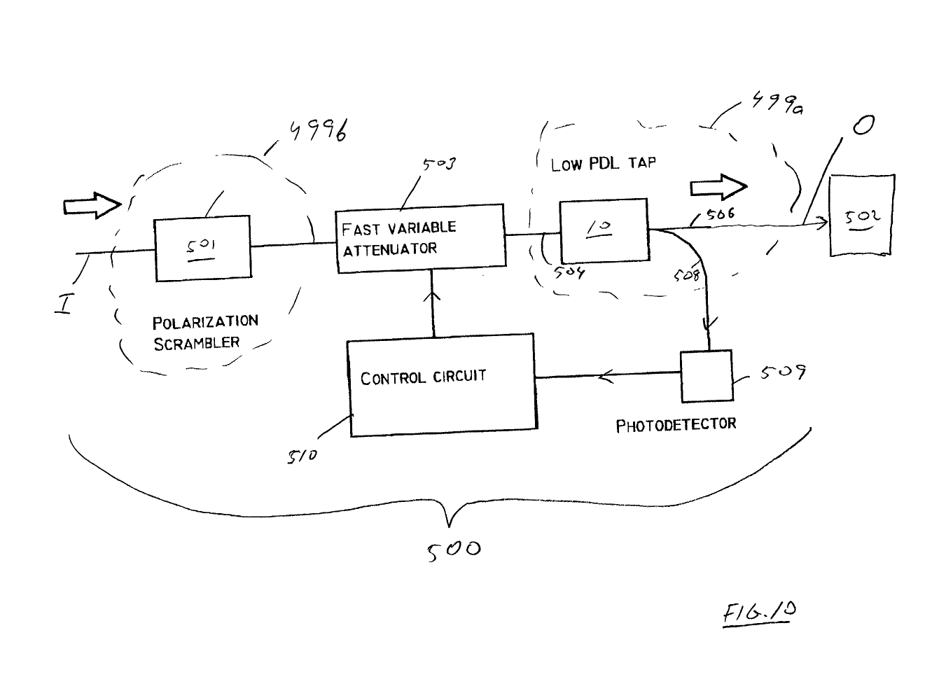

Rather than varying the coupling ratio, in other implementations of the coupler 10, the incoming signal is switched to various output ports one at a time, as illustrated in FIG. 9 for a 1×3 switching coupler module. In this configuration, the three-facet columnar prism 24, similar to that shown in FIG. 2, is used as the splitting prism. In FIG. 9A, the prism 24 is located in the center position so that the light signal from the input fiber 16 is directed through the central facet 39b to the center fiber 20b via the second focusing lens 30. Thus, the central facet 39b intercepts the entire incoming beam. When the splitting prism 24 is moved down, the light beam is incident entirely on the top facet 39a which directs the light beam to the bottom output fiber 20c. And when the prism is moved upwards, the light is directed through the bottom facet 39c so that coupler 10 couples the light from the input fiber 16 with the top output fiber 20a.

In some implementations, the coupler 10 couples light from one PM fiber to a plurality of PM fibers without changing the polarization characteristics of the light. The polarization maintaining coupler will find many applications in optical network monitoring, optical instrumentation, as well as other systems.

As mentioned above, the coupler can be tunable to provide variable coupling ratios. Such a variable coupler with low PDL characteristics is useful as a tap for many devices that need feedback controlling, such as amplifiers, power levelers, and compensators.

For example, there is shown in FIGS. 10A and 10B, the coupler 10 coupled to an output transmission line 499a of a polarization dependent loss compensator 500 which compensates for polarization dependent losses in an optical fiber network 502. The compensator 500 also includes a polarization scrambler 501, manufactured, for example, by General Photonics, CA, coupled to an input transmission line 499b which transmits input signals to a fast variable attenuator 503, manufactured, for example, by Corning Corp., NY. As shown, the compensator is a polarization dependent loss compensator.

The coupler 10 is a 1×2 coupler that receives an input signal from an input fiber 504 and couples the signal to two output fibers 506 and 508. A majority of the light signal is typically transmitted to the network 502 through one of the output fibers, for example, the output fiber 506, while the remaining portion is tapped off and transmitted through the other output fiber 508 to a photodetector 509 which in turn sends signals to a control circuit 510 of the compensator.

In use, an input optical signal, I, is fed to the polarization scrambler 501 which then randomly changes the polarization state of the input signal. The different polarization states causes the power to vary with time. This signal in turn is sent to the attenuator 503 which then sends the signal to the coupler 10 which generally has a PDL that is lower than that of the attenuator 503. A portion of about 0.1% to 10% of the light signal is tapped from the coupler 10 through the fiber 508 and sent to the photodetector 509 which converts the optical signal to an electrical signal, while the remaining portion of the light signal is transmitted through the fiber 506 to the optical network 502. The electrical signal from the photodetector 509 is transmitted to the control circuit 510 which provides feedback signals to the attenuator 503. In essence, the coupler 10 samples the power of each polarization state which is then fed back to the control circuit 510 of the attenuator 503 to attenuate the light signal. Accordingly, the PDL is eliminated from the light signal as the attenuator 503 stabilizes the power level over time.

While this invention has been particularly shown and described with references to preferred embodiments thereof, it will be understood by those skilled in the art that various changes in form and details may be made therein without departing from the scope of the invention encompassed by the appended claims. For example, for certain broadband applications, a coupler with low wavelength dependency loss (WDL), such as the coupler 10, is useful. Such a coupler is able to provide the same coupling ratio for certain amount of channels in a fiber carrying WDM (wavelength division multiplexing) signals.

What is claimed is:

1. A polarization maintaining fiber coupler, comprising:
an input polarization maintaining fiber;
at least two output polarization maintaining fibers;
a multifaceted prism which transmits an input light signal from the input polarization maintaining input fiber to the at least two output polarization maintaining fibers; and
a lens positioned between the prism and theoutput fibers to focus the light signal from the prism.

2. The fiber coupler of claim 1, further comprising a second lens positioned between the input fiber and the prism to collimate the input light signal.

3. The fiber coupler of claim 1 wherein the lens is a GRIN lens.

4. The fiber coupler of claim 1 wherein the prism is coated with an anti-reflection coating.

5. The fiber coupler of claim 4 wherein the coating is a dielectric material.

6. The fiber coupler of claim 1 wherein the prism is made of glass.

7. An low polarization dependent loss coupler, comprising:
a multifaceted prism which couples an input light signal from an input optical fiber to at least two output optical fibers; and
a lens positioned between the prism and the output fibers to focus the light signal from the prism to the output fibers,
the polarization dependent loss of the coupler being less than about 0.05 dB.

8. The coupler of claim 7, further comprising a second lens positioned between the input fiber and the prism to collimate the input light signal.

9. The coupler of claim 7 wherein the polarization dependent loss of the coupler is less than about 0.01 dB.

10. The coupler of claim 7 wherein the input and the output optical fibers are ordinary fibers.

11. The coupler of claim 7 wherein the collimating lens is a GRIN lens.

12. The coupler of claim 7 wherein the prism is coated with an anti-reflection coating.

13. The coupler of claim 12 wherein the coating is a dielectric material.

14. The coupler of claim 7 wherein the prism is made of glass.

15. An low polarization dependent loss coupler, comprising:
a multifaceted prism which couples an input light signal from an input optical fiber to at least two output optical fibers, an angle of incidence of the light signal with the prism being between about 0 to 10 degrees, and
a lens positioned between the prism and the output fibers to focus the light signal from the prism to the output fibers.

16. The coupler of claim 15, further comprising a second lens positioned between the input fiber and the prism to collimate the input light signal.

17. The coupler of claim 15 wherein the input optical fiber and the output optical fibers are polarization maintaining fibers.

18. The coupler of claim 15 wherein the angle of incidence is less than about 8 degrees.

19. The coupler of claim 15 wherein the collimating lens is a GRIN lens.

20. The coupler of claim 15 wherein the prism is coated with an anti-reflection coating.

21. The coupler of claim 20 wherein the coating is a dielectric material.

22. The coupler of claim 15 wherein the prism is made of glass.

23. A tunable optical coupler, comprising:
a multifaceted prism which couples an input light signal from an input optical fiber to at least two output optical fibers; and
a lens positioned between the prism and the output fibers to focus the light signal from the prism,
the proportion of the input light signal being transmitted to each of the output optical fibers being tunable.

24. The coupler of claim 23, further comprising a second lens positioned between the input fiber and the prism to collimate the input light signal.

25. The coupler of claim 23 wherein the input optical fiber is a polarization maintaining fiber.

26. The coupler of claim 23 wherein the output optical fibers are polarization maintaining fibers.

27. The coupler of claim 23 wherein the prism is moved in a plane orthogonal to the optical axis of the prism to vary the proportion of the light signal being sent to each output fiber.

28. The coupler of claim 23 wherein the lens is a GRIN lens.

29. The coupler of claim 23 wherein the prism is coated with an anti-reflection coating.

30. The coupler of claim 29 wherein the coating is a dielectric material.

31. The coupler of claim 23 wherein the prism is made of glass.

32. The coupler of claim 23 wherein the coupler has a polarization dependent loss of less than about 0.01 dB.

33. A optical coupler, comprising:
a multifaceted prism which couples an input light signal from an input optical fiber to at least two output optical fibers;
a first lens positioned between the input fiber and the prism to collimate the input light signal from the input fiber; and
a second lens positioned between the prism and the at least two output fibers to focus the light signal from the prism,
the polarization dependent loss of the coupler being less than about 0.05 dB, and the prism being movable in a plane orthogonal to the optical axis of the prism to vary the proportion of the light signal being sent to each output fiber.

34. A telecommunications system, comprising:
an attenuator which compensates for polarization dependent losses in an optical fiber network;
an input optical transmission line which transmits signals to the attenuator; and
an output optical transmission line that transmits signals from the attenuator;
the input transmission line including a polarization scrambler which randomly changes the polarization state of an input optical signal, the output transmission line including a coupler that couples optical signals from an input optical fiber to two output optical fibers, one of the two output optical fibers being a tap line of the output transmission line that is fed to a control circuit which provides feedback signals to the attenuator, the coupler including a multifaceted prism which receives the input light signal from the input optical fiber and directs a first portion of the light signal to one of the two output optical fibers and a remaining portion of the light signal to the other output optical fiber, and a lens which focuses the light signal from the prism to the output optical fibers.

35. The telecommunications system of claim 34, further comprising a photodetector coupled to the tap line, the photodetector receiving optical signals from the coupler and sending electrical signals to the control circuit.

36. The telecommunications system of claim 34 wherein the coupler includes a second lens which collimates the light signal from the input optical fiber.

37. The telecommunications system of claim 34 wherein the first portion of the light signal is at least 90% of the light signal.

38. The telecommunications system of claim 37 wherein the first portion of the light signal is about 95% of the light signal.

39. The telecommunications system of claim 34 wherein the prism is coated with an anti-reflection coating.

40. The telecommunications system of claim 39 wherein the coating is a dielectric material.

41. The telecommunications system of claim 34 wherein the prism is made of glass.

42. A method of maintaining the polarization in a fiber coupler, comprising:
transmitting an input light signal through an input polarization maintaining fiber to a multifaceted prism; and
focusing selective proportions of the light signal from the prism to at least two respective polarization maintaining output fibers to couple the input light signal to the output optical fibers.

43. The method of claim 42, further comprising collimating the input light signal to the prism.

44. A method of coupling a light signal, comprising:
transmitting a light signal from an input optical fiber to a multifaceted prism; and
focusing selective proportions of the light signal from the prism to at least two respective polarization maintaining output fibers to couple the input light signal to the output optical fibers,
the coupling of the light signal having a polarization dependent loss of less than about 0.05 dB.

45. The method of claim 44, further comprising collimating the input light signal to the prism.

46. The method of claim 44 wherein the coupling has a polarization dependent loss of less than about 0.01 dB.

47. A method of coupling a light signal, comprising:
transmitting a light signal from an input optical fiber to a multifaceted prism; and
focusing selective proportions of the light signal from the prism to at least two respective polarization maintaining output fibers to couple the input light signal to the output optical fibers,
an angle of incidence of the light signal with the prism being between about 0 to 10 degrees.

48. The method of claim 47 wherein the angle of incidence is less than about 8 degrees.

49. The method of claim 47, further comprising collimating the input light signal.

50. A method of coupling a light signal, comprising:
transmitting a light signal from an input optical fiber to a multifaceted prism; and
focusing selective proportions of the light signal from the prism to at least two respective polarization maintaining output fibers to couple the input light signal to the output optical fibers,
the proportion of the input light signal being coupled to each of the output optical fibers being tunable.

51. The method of claim 50, further comprising collimating the input light signal.

52. The method of claim 50, further comprising moving the prism in a plane orthogonal to the optical axis of the prism to vary the proportion of the light signal being sent to each output fiber.

53. A method of coupling a light signal, comprising:
collimating an input light signal from an input optical fiber;
transmitting the collimated light signal from to a multifaceted prism; and
focusing selective proportions of the light signal from the prism to at least two respective polarization maintaining output fibers to couple the input light signal to the output optical fibers; and
moving the prism in a plane orthogonal to the optical axis of the prism to vary the proportion of the light signal being sent to each output fiber,
the polarization dependent loss of the coupling being less than about 0.05 dB.

54. A method of compensating polarization dependent loss in a telecommunications system, comprising:
randomly changing the polarization states of an optical signal and then sending the light signal to an attenuator;
compensating for polarization dependent loss of the optical signal with the attenuator;
transmitting an input light signal from the attenuator to a coupler of an output transmission line; and
coupling the input light signal to two output optical fibers, one of the two output optical fibers being a tap line of the output transmission line that is fed to a control circuit which provides feedback signals to the attenuator, the tap line of the output transmission line providing sampling of the power of each polarization state to determine how much polarization dependent loss exists in the transmission line,
the coupling including transmitting the input light signal to a multifaceted prism, the prism directing a first portion of the light signal to one of the two output optical fibers and a remaining portion of the light signal to the other output optical fiber, and focusing the light signal from the prism to the output optical fibers.

55. The method of claim 54, further comprising collimating the optical signal to the prism.

56. The method of claim 54 wherein the first portion of the light signal is at least 90% of the light signal.

57. The method of claim 56 wherein the first portion of the light signal is about 95% of the light signal.
